(19) United States
(12) Patent Application Publication
(10) Pub. No.: US 2009/0181195 A1
(43) Pub. Date: Jul. 16, 2009

(54) Accumulator Bladder Apparatus and Method of Manufacture

(76) Inventor: Steven T. Jersey, Laguna Niguel, CA (US)

Correspondence Address: GREENBERG TRAURIG (PHX), INTELLECTUAL PROPERTY DEPARTMENT, 2450 COLORADO AVENUE , SUITE 400E, SANTA MONICA, CA, 90404, US

(21) Appl. No.: 12/253,075

(22) Filed: Oct. 16, 2008

Related U.S. Application Data
(60) Provisional application No. 60/999,150, filed on Oct. 16, 2007.

(51) Int. Cl. B29D 23/00

(52) U.S. Cl. 428/35.7; 264/523

(57) ABSTRACT

Embodiments of the disclosure provide a bladder and method of manufacturing the bladder. The bladder includes a hollow body formed of a substantially flexible material and having an inner surface defining a cavity. The bladder also includes a plurality of ribs formed on the inner surface of the hollow body. The ribs extend substantially parallel with respect to a central longitudinal axis of the hollow body and are spaced circumferentially apart from one another. The bladder further includes a support brace positioned on the outer surface of the hollow body. A first end of at least some of the ribs includes a tapered portion being tapered toward the inner surface of the hollow body. The hollow body is self-supporting in any spatial orientation.

### BACKGROUND

Fluid supply systems in industrial, residential, and commercial environments often include one or more accumulator tanks for insuring that the flow rate and pressure of fluid supplied to various locations is substantially steady. Some accumulator tanks contain a reservoir of fluid that can be supplied to the system at peak demand times in order to maintain a substantially steady fluid flow rate and pressure. At times of lower demand, the fluid supply system can replenish such accumulator tanks with fluid.

Accumulator tanks typically include a rigid outer shell having a single aperture through which fluid can flow to and from the fluid supply system. Accumulator tanks also typically include a flexible bladder made from a porous material, such as butyl rubber, positioned within the rigid outer shell. This flexible bladder also has a single aperture aligned with the aperture in the shell and through which fluid can flow to and from the fluid supply system. Fluid enters and exits the bladder through the aligned apertures, and does not contact the rigid outer shell of the accumulator tank.

A problem associated with prior accumulator tanks relates to the bladder, which tends to collapse when empty of fluid primarily because it is made of a flexible material. Small amounts of fluid become trapped in the folds and creases of the collapsed bladder and become stagnant or stale. The trapped fluid is then released into the bladder when the bladder is next filled, potentially contaminating the freshly-added fluid in the bladder with the trapped fluid. Also, when emptied, the bladder will inherently collapse along the same folds and creases. Over time, the collapsing process causes additional stresses along such folds and creases which may contribute to an eventual bladder failure.

### SUMMARY

Some embodiments of the disclosure provide a bladder and method of manufacturing the bladder. The bladder includes a hollow body formed of a substantially flexible material and having an inner surface defining a cavity. The bladder also includes a plurality of ribs formed on the inner surface of the hollow body. The ribs extend substantially parallel with respect to a central longitudinal axis of the hollow body and are spaced circumferentially apart from one another. The bladder further includes a support brace positioned on the outer surface of the hollow body. A first end of at least some of the ribs includes a tapered portion being tapered toward the inner surface of the hollow body. The hollow body is self-supporting in any spatial orientation.

### DESCRIPTION OF THE DRAWINGS

FIG. 1 is a front view of a bladder according to one embodiment of the disclosure.

FIG. 2 is a top view of the bladder of FIG. 1, including a cut-away portion illustrating, in part, the configuration of ribs in the cavity of the bladder according to one embodiment of the disclosure.

FIG. 3 is a bottom view of the bladder of FIG. 1.

FIG. 4 is a side view of the bladder of FIG. 1.

FIG. 5 is a cross-sectional view of the bladder taken along line 5-5 of FIG. 1.

### DETAILED DESCRIPTION

Before any embodiments of the disclosure are explained in detail, it is to be understood that the disclosure is not limited in its application to the details of construction and the arrangement of components set forth in the following description or illustrated in the following drawings. The disclosure is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings. Unless otherwise apparent, or stated, directional references, such as “inner,” “outer,” “upper,” “lower,” etc., or variations thereof, are intended to be relative to the parts described or orientation of a particular embodiment of the disclosure as shown in the first view of that embodiment.

The following discussion is presented to enable a person skilled in the art to make and use embodiments of the disclosure. Various modifications to the illustrated embodiments will be readily apparent to those skilled in the art, and the generic principles herein can be applied to other embodiments and applications without departing from embodiments of the disclosure. Thus, embodiments of the disclosure are not intended to be limited to embodiments shown, but are to be accorded the widest scope consistent with the principles and features disclosed herein. The following detailed description is to be read with reference to the figures, in which like elements in different figures have like reference numerals. The figures, which are not necessarily to scale, depict selected embodiments and are not intended to limit the scope of embodiments of the disclosure. Skilled artisans will recognize the examples provided herein have many useful alternatives and fall within the scope of embodiments of the disclosure.

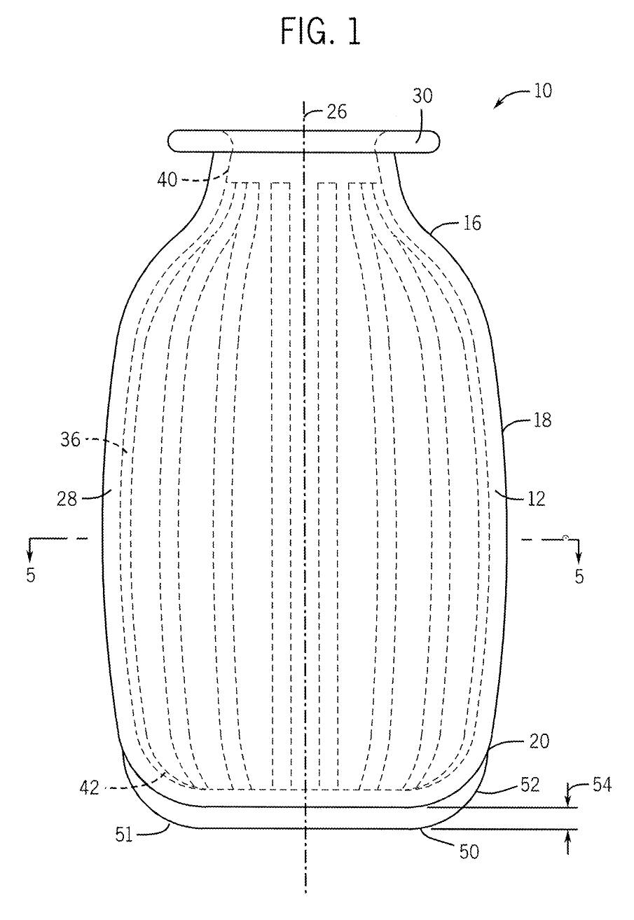

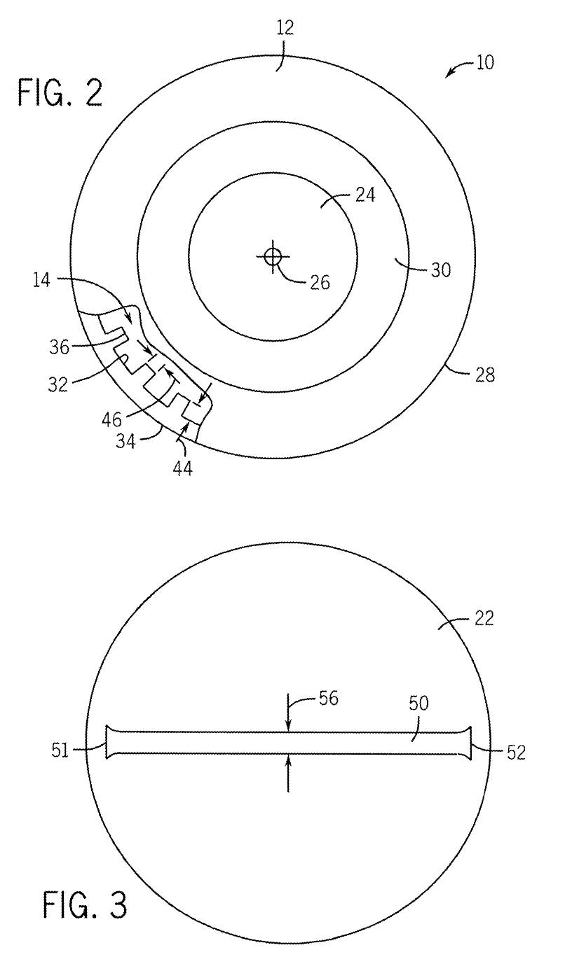

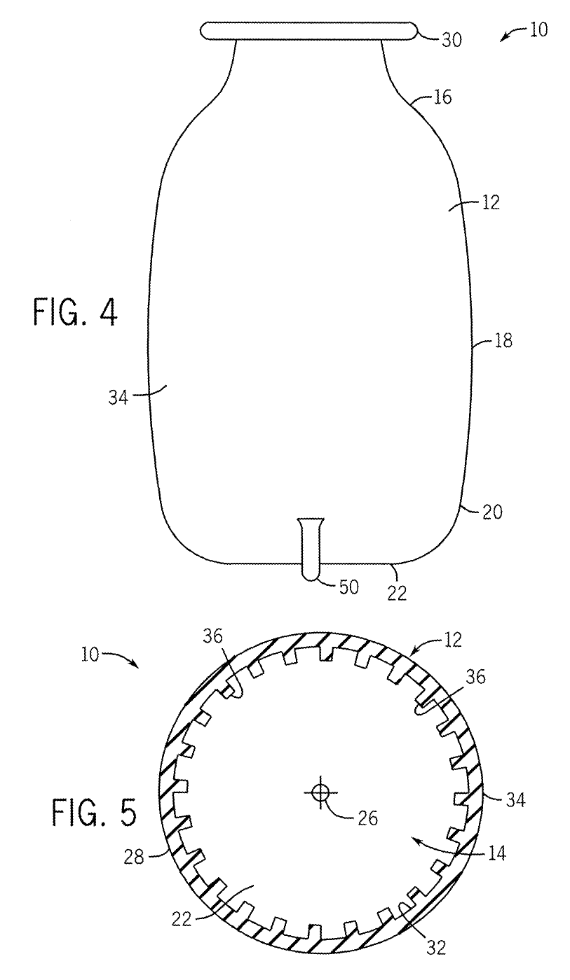

FIGS. 1-5 illustrate a self-supporting bladder 10 constructed and configured according to one embodiment of the disclosure. Bladder 10 can comprise a flexible material, including without limitation, a variety of polymers, such as elastomers. For example, bladder 10 can comprise a natural rubber or a synthetic rubber (e.g., butyl, or other types of rubber). However, a flexible material having few or no pores can provide good performance results. In some embodiments, the flexible material can include latex; urethane; thermoplastic elastomer (TPE) or thermoplastic elastomer blend (e.g., a styrene block copolymer (SBS and SEBS), impact modified and super soft polypropylene, thermoplastic vulcanizate (TPV) (e.g., a polyolefinic blend of polypropylene and crosslinked ethylene-propylene diene monomer (EPDM)), thermoplastic polyurethanes (TPU), Melt Processible Rubber (MPR), thermoplastic copolyesters (TPEF), and thermoplastic polyamides); ethyl vinyl acetate (EVA), ethylene propylene diene monomer (EPDM), ethylene propylene copolymer, polyvinyl chloride (PVC), and any combination thereof. In some embodiments, bladder 10 comprises a TPE-TPV alloy (e.g., a TPE-NEXPENE° alloy; NEXPRENE® available from Solvay Engineered Polymers), which can essentially have no pores and is substantially tasteless.

Bladder 10 can have a body 12 with an internal bladder cavity 14 defined therein. The body 12 can have any shape desired, including, for example, spherical, conical, egg shaped or a combination thereof. In some embodiments, the body 12 has an upper substantially concave portion 16 which tapers inwardly and upwardly, a generally cylindrical middle portion 18, and a truncated lower portion 20 forming a floor 22. In some embodiments, bladder 10 can also be fitted with an inlet aperture 24 through which fluid can enter bladder 10. Inlet aperture 24 can be substantially circular, although inlet aperture 24 can instead be rectangular, oval, irregular, or can have any other shape desired.

In some embodiments, inlet aperture 24 is approximately centrally located in upper concave portion 16 of bladder 10, and can be approximately centered with respect to a central axis 26 of bladder 10. Inlet aperture 24 can alternatively be fitted in other portions of bladder 10, such as in a sidewall 28 of bladder 10, located eccentrically with respect to axis 26 of the bladder 10, etc. In some embodiments, bladder 10 can include an inlet bladder flange 30 adjacent inlet aperture 24.

In some embodiments, central axis 26 is a longitudinal axis with respect to the configuration of body 12. Central axis 26 can also be an axis of symmetry with respect to body 12 in other embodiments.

Body 12 of bladder 10 generally includes an inner surface 32 and an outer surface 34. In some embodiments, outer surface 34 is generally depicted as being smooth. However, outer surface 34 can have texture, grooves, ridges or other regular or irregular surface features as desired.

Body 12 can include a plurality of longitudinal ridges or ribs 36 that extend axially with respect to central axis 26 along inner surface 32 of the body 12 and protrude radially into bladder cavity 14. Ribs 36 can be positioned substantially equidistant laterally from one another about the circumference of the entire inner surface 32. In other embodiments, ribs 36 can be in any symmetrical or asymmetrical spatial relationship with respect to one another at different locations about body 12. In yet other embodiments, ribs 36 can have various other configurations with respect to body 12, including extending circumferentially, axially, radially, or include circumferential, axial and radial portions. In some embodiments, ribs 36 are unitary and extend continuously along inner surface 32. In other embodiments, some or all ribs 36 may not be unitary or extend continuously along inner surface 32.

Ribs 36 can extend axially along all or a portion of the inner surface 32 of body 12 from floor 22 of body 12 to upper portion 16 of body 12. In some embodiments, an upper end 40 of each rib 36 is located adjacent inlet aperture 24 and a lower end 42 of each rib 36 is located along floor 22 of body 12. Upper and lower ends 40 and 42 of ribs 36 can each include axially tapered portions (not shown) which gradually culminate in a substantially planar transition between upper and lower ends 40 and 42 of each rib 36 and inner surface 32, respectively. In other embodiments, however, upper and lower ends 40 and 42 of ribs 36 can form a more abrupt or uneven transition with inner surface 32 of body 12. Furthermore, in yet other embodiments, the transitional portions at upper end 40 of ribs 36 can differ variously from the transitional portions at lower end 42 of ribs 36.

Ribs 36 in some embodiments have a substantially rectangular cross-sectional profile. In other embodiments, however, ribs 36 can have cross-sectional profiles of varying sizes and shapes. For example, ribs 36 may have a -cross-sectional profile which is substantially square, triangular, round or oval, or ribs 36 can include portions thereof. Furthermore, while in some embodiments all of the ribs 36 have the same cross-sectional shape, in other embodiments, ribs 36 can have different cross-sectional shapes from one another. In addition, the cross-sectional shape of each ridge 36 can be approximately the same from the upper end 40 to the lower end 42, as shown in the illustrated embodiment, or can change from one shape to another (not shown).

Ribs 36 can have a variety of height (i.e., radially inward) dimensions 44 and width (i.e., circumferentially across) dimensions 46. In one embodiment, height 44 of ribs 36 is about ⅛ inch (about 3.175 mm) and width 46 of the ribs 36 is about ¼ inch (about 6.35 mm). The height 44 and/or width 46 of the ridges 36 can be of any size smaller or larger depending on factors such as the size, shape, construction and/or material associated with the fabrication of bladder 10. For example, smaller ribs 36 may be selected if body 12 is made of a rigid material. Conversely, the height 44 and or width 46 of the ridges can be greater if body 12 is larger and/or if body 12 is made of a materially of less rigid material.

Bladder 10 can include one or more exterior support features. In some embodiments, a support brace 50 is operatively associated with outer surface 34 of body 12. Support brace 50 can be formed with bladder 12, mounted thereon or otherwise affixed to bladder 12. In some embodiments, support brace 50 protrudes from the outer surface 34 of body 12 at floor 22, and extends diametrically along floor 22, that is, substantially perpendicularly with respect to central axis 26 of the body 12. Support brace 50 has a first end 51 and a second end 52, both of which, as shown, include inwardly tapered portions which gradually culminate in a substantially planar transition between first and second ends 51 and 52 of brace 50 and sidewall 28 of outer surface 34, respectively. Support brace 50 can have a rectangular cross-sectional profile as generally illustrated, or may have a cross-sectional profile of various shapes and sizes. For example, support brace 50 may have a cross-sectional profile which is substantially square, triangular, round or oval.

Support brace 50 can extend diametrically across the width of the floor 22, as shown, or brace 50 can extend over a portion thereof. Support brace 50 can have a variety of height (axial) dimensions 54 and width (radial) dimensions 56. In one embodiment, height 54 of support brace 50 is approximately ½″ and width 56 of support brace 50 is approximately ¼″. Height 54 and/or width 56 of support brace 50 can be variously smaller or larger depending on factors such as the size, shape, construction and/or materials associated with the fabrication of bladder 10. For example, if body 12 is smaller, and/or if body 12 is made of a rigid material, support brace 50 may be sized suitably smaller. Conversely, height 54 and or width 56 of support brace 50 can be greater if body 12 is larger and/or if body 12 is made of a less rigid material. Support brace 50 can be constructed of any material, including the material used in the construction of body 12. Support brace 50 can also be of greater rigidity than body 12.

Bladder 10 provides a self-supporting, flexible bladder which helps prevent collapse under the pressure of its own weight and helps prevent deforming to a condition which traps fluids. Bladder 10 can be formed of a soft, flexible material, as previously described, yet substantially retain its shape regardless of how oriented. For example, bladder 10 can be positioned with tapered upper end 16 oriented upwardly or downwardly, or bladder 10 can rest on bladder sidewall 28, while helping to prevent collapsing or deforming.

Bladder 10 further provides a bladder for an accumulator tank or other application that helps prevent collapse when substantially empty of fluids. Bladder 10 substantially retains its shape without creasing or folding, thereby preventing fluid or other materials from being trapped and becoming stagnant. In addition, bladder 10 is subjected to fewer stresses due to the folding or creasing of body 12, thereby increasing the usable life of the bladder 10, among other things.

It will be appreciated by those skilled in the art that while the disclosure has been described above in connection with particular embodiments and examples, the disclosure is not necessarily so limited, and that numerous other embodiments, examples, uses, modifications and departures from the embodiments, examples and uses are intended to be encompassed by the claims attached hereto. The entire disclosure of each patent and publication cited herein is incorporated by reference, as if each such patent or publication were individually incorporated by reference herein.

Various features and advantages of the disclosure are set forth in the following claims.

1. A bladder comprising:
a hollow body formed of a substantially flexible material defining an outer surface and a cavity including an inner surface;
an aperture formed in the body to be in fluid communication with the cavity;
a plurality of ribs formed on the inner surface of the hollow body, the plurality of ribs extending substantially parallel with respect to a central axis of the hollow body, wherein each rib of the plurality of ribs is circumferentially spaced apart from one another; and
a support brace positioned on the outer surface of the hollow body, the support brace at least including a portion which transverses the central axis of the hollow body, the hollow body being self-supporting in any spatial orientation.

2. The bladder of claim 1, further comprising a flange formed substantially about the aperture.

3. The bladder of claim 1, wherein the support brace and the aperture are positioned at substantially opposing portions of the hollow body.

4. The bladder of claim 1, wherein the central axis comprises an axis of symmetry relative to the configuration of the bladder.

5. The bladder of claim 1, wherein the hollow body includes a concave first end, a truncated second end, and a substantially cylindrical portion between the first end and the second end.

6. The bladder of claim 5, wherein the support brace is mounted on the truncated second end.

7. The bladder of claim 1, wherein the support brace extends an entire width of the hollow body.

8. The bladder of claim 1, wherein at least a first end of at least some of the plurality of ribs taper toward the inner surface of the hollow body.

9. The bladder of claim 1, wherein the hollow body is formed of at least one of an elastomer, a natural rubber, a synthetic rubber, a latex, a urethane, a thermoplastic elastomer, a thermoplastic elastomer blend, an impact modified and super soft polypropylene, a thermoplastic vulcanizate, a thermoplastic polyurethane, an ethyl vinyl acetate, an ethylene propylene diene monomer, an ethylene propylene copolymer, and a polyvinyl chloride.

10. A bladder comprising:
a hollow elongated body formed of a substantially flexible material and having an inner surface defining a cavity; and
a plurality of ribs formed on the inner surface of the hollow body having a first end and a second end, each rib of the plurality of ribs extending substantially parallel to a central longitudinal axis of the hollow elongated body and being spaced circumferentially apart from one another, the first end of at least some of the plurality of ribs including a tapered portion being tapered toward the inner surface of the hollow body, the hollow body being self-supporting in any spatial orientation.

11. The bladder of claim 10 wherein the second end of at least some of the plurality of ribs includes a tapered portion being tapered toward the inner surface of the hollow body.

12. The bladder of claim 11 wherein the hollow body has a concave first end, a truncated second end, and a substantially cylindrical portion between the concave first end and the truncated second end.

13. The bladder of claim 12 wherein the tapered first end of the plurality of ribs taper toward the inner surface of the hollow body adjacent the concave first end of the hollow body.

14. The bladder of claim 12 wherein the tapered second end of the plurality of ribs taper toward the inner surface of the hollow body at a floor portion of the hollow body adjacent the truncated second end of the hollow body.

15. The bladder of claim 10 wherein each rib of the plurality of ribs includes a first portion extending substantially parallel with respect to the central axis of the hollow body and a second portion extending substantially transverse with respect to the central axis of the hollow body.

16. The bladder of claim 10 further comprising a support feature formed on an outer surface of the hollow body and extending transverse to the central axis of the hollow body.

17. The bladder of claim 10 wherein the hollow body is formed of at least one of an elastomer, a natural rubber, a synthetic rubber, latex, a urethane, a thermoplastic elastomer, a thermoplastic elastomer blend, an impact modified and super soft polypropylene, a the thermoplastic vulcanizate, a thermoplastic polyurethane, an ethyl vinyl acetate, an ethylene propylene diene monomer, an ethylene propylene copolymer, and a polyvinyl chloride.

18. A method of manufacturing a self-supporting bladder, the method comprising:
forming a hollow body of a substantially flexible material defining an outer surface and a cavity including an inner surface;
forming an aperture in the body to be in fluid communication with the cavity;
forming a plurality of ribs on the inner surface of the hollow body, the plurality of ribs extending substantially parallel with respect to a central axis of the hollow body, each rib of the plurality of ribs being circumferentially spaced apart from one another; and
forming a support brace positioned on the outer surface of the hollow body, the support brace at least including a portion which transverses the central axis of the hollow body, the hollow body being self-supporting in any spatial orientation.

19. The method of claim 18 further comprising forming a first end of the plurality of ribs tapered toward the inner surface of the hollow body.

20. The method of claim 18 further comprising forming the hollow body of at least one of an elastomer, a natural rubber, a synthetic rubber, a latex, a urethane, a thermoplastic elastomer, a thermoplastic elastomer blend, an impact modified and super soil polypropylene, a thermoplastic vulcanizate, a thermoplastic polyurethane, an ethyl vinyl acetate, an ethylene propylene diene monomer, an ethylene propylene copolymer, and a polyvinyl chloride.
